(19) United States
(12) Patent Application Publication
(10) Pub. No.: US 2017/0216848 A1
(43) Pub. Date: Aug. 3, 2017

(54) ROLLER AND PRESS APPARATUS INCLUDING THE SAME

(71) Applicants: Ke ZHANG, Chongqing (CN); Jincai ZHANG, Chongquing (CN); Yangdong HU, Chongqing (CN)

(72) Inventors: Ke ZHANG, Chongqing (CN); Jincai ZHANG, Chongquing (CN); Yangdong HU, Chongqing (CN)

(21) Appl. No.: 15/501,127

(22) PCT Filed: Jul. 9, 2015
(86) PCT No.: PCT/CN2015/083674

§ 371 Date: Feb. 1, 2017

(30) Foreign Application Priority Data
Aug. 1, 2014 (CN) 201410376414.4

(51) Int. Cl. B02C 4/30

(52) U.S. Cl. CPC B02C 4/305; B02C 2210/02

(57) ABSTRACT

A roller comprising a roller body (2) on which a plurality of ribs (4) are arranged, wherein each of the ribs (4) are formed of a number of protrusions (5) which are disposed continually in a direction of the roller shaft, the protrusions (5) are made from materials having a high wear-resisting property. This arrangement not only improve the primary yield of finished products, but also increase the lifetime and wear-resisting property, thereby the primary yield of finished products in present invention is up to 22%-30%, and the lifetime of the roller is up to 15,000-20,000 hours, further the wear loss of the stud is only 2.5 mm per 2,100 hours.

### PRIORITY

This application is a National Phase Entry of PCT International Application No. PCT/CN2015/083674, which was filed on Jul. 9, 2015, claiming priority to Chinese Application No. 201410376414.4 filed Aug. 1, 2014, the contents of each of which are incorporated herein by reference.

### TECHNICAL FIELD

The present invention relates to a roller used for grinding and pulverization. Also, the invention relates a press apparatus including the roller.

### BACKGROUND

A roller is usually configured in a press apparatus, used for grinding and pulverizing materials. Typically, the materials are pressed by a roller where some protrusions are configured on the surface of the roller. The protrusions in existing apparatus are typically a number of studs which are configured on the surface of the roller, in which there are intervals between the studs, thus the materials are pressed by the studs when roller works, and thereby the materials are ground and pulverized. However, such stud roller has a low primary yield of finished products, e.g. 10%-16%, to get the desired materials. The stud roller has a lifetime of 12,000-15,000 hours, and the wear loss of the stud is 3.2 mm per 2,100 hours.

### SUMMARY OF THE INVENTION

The aspect relates to a roller and a roller press apparatus having a high primary yield of finished products.

This aspect can be achieved by the following solution:

A roller comprising a roller shaft, and a roller body on which a plurality ribs are arranged, each of the ribs are formed of a number of protrusions which are disposed continually in a direction of the roller shaft, and are made from materials having a high wear-resisting property. This design is capable of improving the primary yield of finished products for the roller.

To further improve the wear-resisting property of the roller, the materials having a high wear-resisting property may be hard alloy, ceramic and so on. Preferably, the material is hard alloy which is more suitable for the roller in aspects of brittleness, flexure strength, and impact toughness.

To further increase the lifetime of the roller, the protrusions are connected to the roller body through grooves which are set on the roller body, and the protrusions are embedded in the grooves. This arrangement significantly improves the lifetime of the roller, and avoids crack formed in the protrusions along surface of the roller body. The embedment can be either in the form of an interference fit, or in the form of a clearance fit. The clearance fit may be fixed by adhesive or welding, but adhesive way is preferable. The clearance fit will be better than the interference fit in this regard, and also prevents thermal expansion and contraction of the groove from impacting the connective portion.

To further increase the lifetime of the roller, a bottom width of the protrusions is equivalent to or larger than a width at an intersection plane of the protrusions and the surface of the roller. Even if the protrusions crack in a radial direction of the roller body, it does not intervene the utilization of the roller.

To further increase the lifetime of the roller, a cross section of the protrusions may be a rectangle, a trapezoid, L-shape, T-shape, convex and so on. The cross section of the protrusions is preferably trapezoid, which is easily processed, and is difficult to come off even as the protrusions are worn.

To further improve the wear-resisting property of the roller, a relative height of a protruded portion of the protrusions from the surface of the roller is 15%-30% of a height of the entire protrusion. This arrangement improves the wear-resisting property and lifetime of the roller.

To further improve the primary yield of finished products of the roller, a height of the protruded portion of the protrusions from the surface of the roller, is 4-7 mm.

To further increase the lifetime of the roller, the protrusions, which form one rib, have identical height from the surface of the roller.

Layout of the protrusions on the surface of the roller can be straight strip-shaped, M-shaped, A-shaped, arc-shaped and so on. The straight strip-shape is preferable, as it provides an advantage for processing the grooves and protrusions with low cost.

To further improve the primary yield of finished products for the roller, flanges are provided on either side of the roller, wherein the flanges are embedded between two adjacent ribs. Preferably, the flanges have a height identical to the height of the ribs, which further improves primary yield of finished products.

Said protrusions may be sized in one or two dimensions, thus protrusions can have any width, and this flexible arrangement reduces the cost to make a mold and produce the roller, while enhances the universality and interchangeability of the protrusions.

In the present invention, said roller can be either an integrated one including a roller shaft and a body, or an assembly one combining a roller shaft with a body.

The roller in the present invention not only improves the primary yield of finished products, but also increases the lifetime and wear-resisting property. The primary yield of finished products in present invention is up to 22%-30%, and the lifetime of the roller is up to 15,000-20,000 hours, further the wear loss of the stud is only 2.5 mm per 2,100 hours.

### BRIEF DESCRIPTION OF THE DRAWINGS

The above and other aspects, features and advantages of embodiments of the present invention will be more apparent from the following detailed description taken in conjunction with the accompanying drawings, in which:

FIG. 1 shows a structural schematic view of a roller according to embodiment of the present invention;

FIG. 2 shows a cross-section view of a trapezoidal protrusion according to embodiment of the present invention;

FIGS. 3(a) to 3(d) are views of various protrusion layouts on a surface of the roller according to embodiments of the present invention; and

FIGS. 4(a) to 4(e) are cross-sectional views of various protrusions according to embodiments of the present invention.

### DETAILED DESCRIPTION OF THE PREFERRED EMBODIMENTS

The present invention will be described hereinafter with reference to embodiments and figures, however, it will be understood that the present invention is not limited by the embodiments, instead any numerous additional modifications and variations could be made thereto without departing from the scope of the invention.

### Embodiment 1

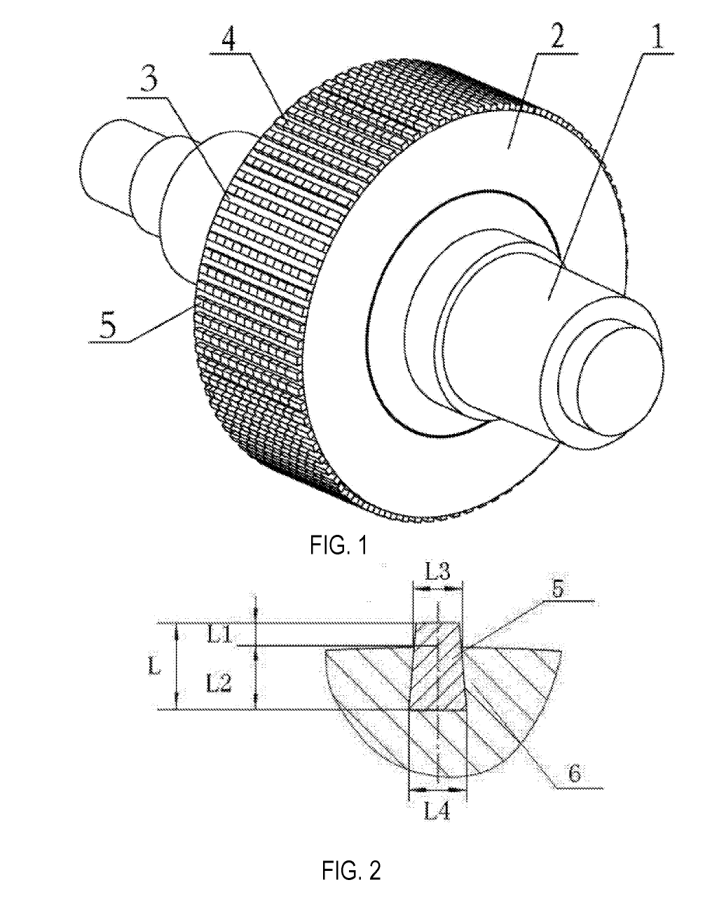

A roller shown in FIG. 1 comprises a roller shaft 1, and a roller body 2 on which a plurality of ribs 4 are arranged, each of the ribs 4 are formed of a number of protrusions 5 which are disposed continually in a direction of the roller shaft. Further, the protrusions 5 are made from materials having a high wear-resisting property. The roller is configured in a press apparatus such as a roller press, a vertical roller mill.

For this roller, a primary yield of finished products is improved to 22%, and its lifetime is improved to 15,000 hours, and the wear loss of the stud is decreased to 2.5 mm per 2,100 hours.

### Embodiment 2

A roller shown in FIG. 1 comprises a roller shaft 1, and a roller body 2 on which a plurality of ribs 4 are arranged, each of the ribs 4 are formed of a number of protrusions 5 which are disposed continually in a direction of the roller shaft, and the protrusions 5 are made from hard alloy having a high wear-resisting property, wherein a height L1, a height of the protruded portion of the protrusions 5 from the surface 3 of the roller, is 7 mm.

Further as shown in FIG. 1, the protrusions 5, which form one rib 4, have identical height from the surface 3 of the roller. This roller is configured in a press apparatus such as a roller press, a vertical roller mill.

For this roller, a primary of finished products is improved to 25%, and its lifetime is improved to 16,500 hours, and the wear loss of the stud is decreased to 2.5 mm per 2,100 hours.

### Embodiment 3

A roller shown in FIG. 1 comprises a roller shaft 1, and a roller body 2 on which a plurality of ribs 4 are arranged, each of the ribs 4 are formed of a number of protrusions 5 which are disposed continually in a direction of the roller shaft, further the protrusions 5 are made from hard alloy having a high wear-resisting property. The protrusions 5 are connected to the roller body 2 through grooves 6 which are set on the roller body 2, and the protrusions 5 are embedded in the grooves 6.

As shown in FIG. 2, a bottom width L4 of the protrusion 5 is equivalent to or larger than a width L3 at an intersection plane of the protrusion 5 and the surface 3 of the roller, a height L1, a height of the protruded portion of the protrusion 5 from the surface 3 of the roller body, is 7 mm, and a height L of entire protrusion 5 is 47 mm.

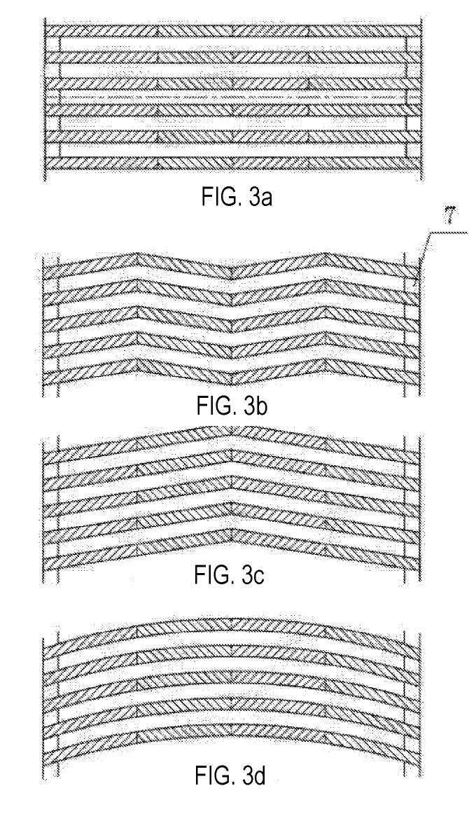

The protrusions 5, which form one rib 4, have identical height from the surface 3 of the roller. As shown in FIG. 3(a), the protrusions 5 are square ribs in shape and are disposed in straight strip-shaped to form the rib 4 on surface 3 of the roller body. The roller is configured in a press apparatus such as a roller press, a vertical roller mill. As shown in FIG. 3(b), the protrusions 5 can be disposed in an M-shape. As shown in FIG. 3(c), the protrusions 5 can be disposed in an inverted V shape.

As shown in FIG. 3(d), the protrusions 5 can be disposed in an arc shape.

For this roller, a primary yield of finished products is improved to 27%, and its lifetime is improved to 18,000 hours, and the wear loss of the stud is decreased to 2.5 mm per 2,100 hours.

### Embodiment 4

A roller shown in FIG. 1 comprises a roller shaft 1, and a roller body 2 on which a plurality of ribs 4 are arranged, each of the ribs 4 are formed of a number of protrusions 5 which are disposed continually in a direction of the roller shaft, and the protrusions 5 are made from hard alloy having a high wear-resisting property. The protrusions 5 are connected to the roller body 2 through grooves 6 which are set on the roller body 2, while the protrusions 5 are embedded in the grooves 6, and the embedment therebetween is in the form of a clearance fit plus adhesive.

As shown in FIG. 2, a bottom width L4 of the protrusion 5 is equivalent to or larger than a width L3 at an intersection plane of the protrusion 5 and the surface 3 of the roller body, and the cross section of the protrusions 5 is a trapezoid. A height L1, a height of the protruded portion of the protrusion 5 from the surface 3 of the roller body, is 4 mm, and a height L of entire protrusion 5 is 14 mm.

As shown in FIG. 1, the protrusions 5, which form one rib 4, have identical height from the surface 3 of the roller, and the protrusions 5 are disposed in straight strip-shaped to form the rib 4 on the surface 3 of the roller body. The roller is configured in a press apparatus such as a roller press, a vertical roller mill.

For this roller, a primary yield of finished products is improved to 28%, and its lifetime is improved to 19,000 hours, and the wear loss of the stud is decreased to 2.5 mm per 2,100 hours.

### Embodiment 5

A roller shown in FIG. 1 comprises a roller shaft 1, and a roller body 2 on which a plurality of ribs 4 are arranged, each of the ribs 4 are formed of a number of protrusions 5 which are disposed continually in a direction of the roller shaft, and the protrusions 5 are made from hard alloy having a high wear-resisting property. The protrusions 5 are connected to the roller body 2 through grooves 6 which are set on the roller body 2, while the protrusions 5 are embedded in the grooves 6, and the embedment therebetween is in the form of a clearance fit plus adhesive.

As shown in FIG. 2, a bottom width L4 of the protrusion 5 is equivalent to or larger than a width L3 at an intersection plane of the protrusion 5 and the surface 3 of the roller body, and the cross section of the protrusions 5 is a trapezoid. A height L1, a height of the protruded portion of the protrusions 5 from the surface 3 of the roller body, is 5 mm, and a height L of entire protrusion 5 is 30 mm, with L2 being 25 mm.

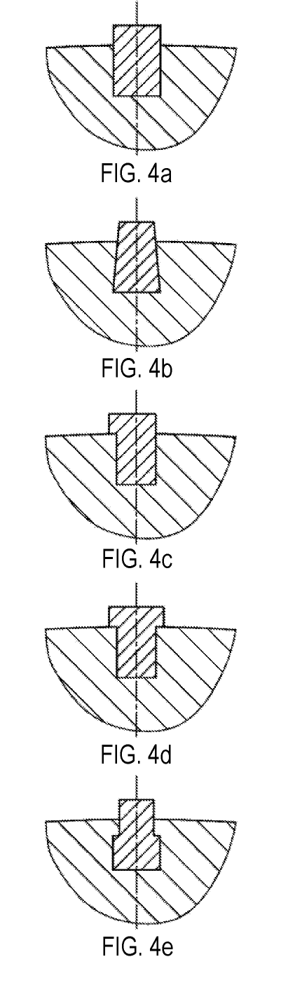

FIGS. 4(a) to 4(e) are cross-sectional views of various protrusions according to embodiments of the present invention. FIG. 4(a) illustrates a rectangle shaped protrusion. FIG. 4(b) illustrates a trapezoid shaped protrusion. FIG. 4(c) illustrates an L-shaped protrusion. FIG. 4(d) illustrates a T-shaped protrusion. FIG. 4(e) illustrates a convex shaped protrusion.

As shown in FIG. 1, the protrusions 5, which form one rib 4, have identical height from the surface 3 of the roller, and the protrusions 5 are disposed in straight strip-shaped to form the rib 4 on the surface 3 of the roller body. Flanges 7 are provided on either side of the roller body, and the flanges 7 have a height identical to the height of the ribs 4. The roller is configured in a press apparatus such as a roller press, a vertical roller mill.

For this roller, a primary yield of finished products is improved to 30%, and its lifetime is improved to 20,000 hours, and the wear loss of the stud is decreased to 2.5 mm per 2,100 hours.

While the present invention has been particularly shown and described with reference to certain embodiments thereof, various changes in form and detail may be made therein without departing from the spirit and scope of the present disclosure as defined by the following claims and their equivalents.

1. A roller, comprising a roller body (2) on which a plurality of ribs (4) are arranged,
wherein each rib of the plurality of ribs (4) is formed of a number of protrusions (5) which are disposed continually in a direction of the roller shaft, and
wherein the number of protrusions (5) are made from materials having a high wear-resisting property.

2. The roller of claim 1, wherein the materials having a high wear-resisting property include a hard alloy.

3. The roller of claim 1, further comprising a plurality of grooves (6) set on the roller body (2),
wherein the number of protrusions (5) are received by a respective groove of the plurality of grooves (6).

4. The roller of claim 3, wherein the number of protrusions (5) are received by the respective groove of the plurality of grooves (6) in the form of embedment.

5. The roller of claim 4, wherein the form of embedment is a clearance fit.

6. The roller of claim 5, wherein each of the number of protrusions (5) is fixed to the respective groove of the plurality of grooves (6) in the form of a clearance fit, using adhesive.

7. The roller of claim 3, wherein a bottom width (L4) of the number of protrusion (5) is equivalent to or larger than a width (L3) at an intersection plane of the number of protrusions (5) and a surface (3) of the roller body.

8. The roller of claim 1, wherein the a cross section of the number of protrusions (5) forms a trapezoid.

9. The roller of claim 1, wherein a height of a portion of a protrusion of the number of protrusions (5) that is configured to be securably attached within the roller body (2) is approximately 15%-30% of an entire height of the protrusion.

10. The roller of claim 1, wherein a height of a portion of a protrusion of the number of protrusions (5) that is configured to be securably attached within the roller body (2) is 4-7 mm from a surface (3) of the roller body.

11. The roller of claim 1, wherein the number of protrusions (5) form one rib (4) having an identical height from a surface (3) of the roller body.

12. The roller of claim 1, wherein the number of protrusions (5) are disposed as a straight strip to form a rib of the plurality of ribs (4) on a surface (3) of the roller body.

13. The roller of claim 1, further comprising a flange (7) provided on each side of the roller body.

14. The roller of claim 13, wherein each flange (7) is embedded between adjacent ribs (4).

15. The roller of claim 13, wherein each flange (7) has a height identical to a height of the plurality of ribs (4).

16. A roller press comprising a roller, the roller comprises a roller body (2) on which a plurality of ribs (4) are arranged,
wherein each rib of the plurality of ribs (4) is formed of a number of protrusions (5) which are disposed continually in a direction of the roller shaft, and
wherein the number of protrusions (5) are made from materials having a high wear-resisting property.

17. A vertical roller mill comprising a roller, the roller comprises a roller body (2) on which a plurality of ribs (4) are arranged,
wherein each rib of the plurality of ribs (4) is formed of a number of protrusions (5) which are disposed continually in a direction of the roller shaft, and
wherein the number of protrusions (5) are made from materials having a high wear-resisting property.

18. The roller of claim 3, wherein a cross section of the number of protrusions (5) forms a trapezoid.

19. The roller of claim 4, wherein a cross section of the number of protrusions (5) forms a trapezoid.

20. The roller of claim 14, wherein each flange (7) has a height identical to the height of the plurality of ribs (4).
